(19) United States
(12) Patent Application Publication
(10) Pub. No.: US 2026/0128919 A1
(43) Pub. Date: May 7, 2026

(54) CONFERENCING SYSTEM WITH MULTI-MODAL SENSING AND CONTEXTUAL MODEL TRAINING

(71) Applicant: QSC, LLC, Costa Mesa, CA (US)

(72) Inventors: James Michael DALLAS, Superior, CO (US); Matthew SKOGMO, Placentia, CA (US); Damian Andrea FRICK, Wallisellen (CH); Ryan PRING, Boulder, CO (US)

(73) Assignee: QSC, LLC, Costa Mesa, CA (US)

(21) Appl. No.: 19/379,200

(22) Filed: Nov. 4, 2025

Related U.S. Application Data
(60) Provisional application No. 63/716,521, filed on Nov. 5, 2024.

(51) Int. Cl. H04L 12/18

(52) U.S. Cl. CPC H04L 12/1822

(57) ABSTRACT

A conferencing system may position a sensor array in a meeting space and detect, with the sensor array, an activity of a participant present in the meeting space. A computing device connected to the sensor array may assign at least one identifier to describe the activity prior to characterizing the at least one identifier as a behavioral context. In response to the behavioral context, the computing device may alter at least one operational parameter of the sensor array.

### CROSS REFERENCE TO RELATED APPLICATIONS

This application claims the benefit of U.S. Provisional Application Nos. 63/716,521 filed November 5, 2024, which is currently pending, the disclosure of which is hereby incorporated by reference herein in its entirety.

### SUMMARY

Embodiments of the present disclosure are generally directed to a conferencing system employing multi-modal sensing to intelligently understand a conferencing environment that can be utilized to gather conference participant behavior, assign context to the gathered information, and train one or more intelligence models with the participant’s contextual actions.

In some embodiments of a conferencing system, a sensor array may be positioned in a meeting space and used to detect activity of a participant present in the meeting space. A computing device connected to the sensor array may assign at least one identifier to describe the activity prior to characterizing the at least one identifier as a behavioral context. In response to the behavioral context, the computing device may alter at least one operational parameter of the sensor array.

Embodiments of a conferencing system may position a sensor array in a meeting space and sense, with the sensor array, at least one condition of the meeting space. The sensor array may detect a first participant present in the meeting space, a second participant present in the meeting space, and an activity of the first participant. A computing device connected to the sensor array may assign at least one identifier to describe the activity and characterize the at least one identifier as a relationship based on a relationship strategy. The computing device may verify the assigned relationship in response to detected behavior of the first participant.

Other embodiments of a conferencing system may position a sensor array within a meeting space with the sensor array having an initial set of operating parameters. A computing device may be connected to the sensor array and activity of at least two participants may be detected by the sensor array. The computing device may assign at least one identifier to the detected activity and generate a relationship strategy prescribing a relationship set of operating parameters for the sensor array to detect interpersonal relationships between meeting participants. The computing device may designate an initial relationship status to a pair of meeting participants in response to the activation of the relationship set of operating parameters for the sensor array. The computing may generate a context strategy prescribing a context set of operating parameters for the sensor array to detect behavior of at least two meeting participants and assign identifiers to detected behavior of a meeting participant with the identifiers describing meaning corresponding with the detected behavior. The computing device may generate a conferencing strategy prescribing a content set of operating parameters for the sensor array to collect audio content and video content from meeting participants with customized accuracy and conduct context analysis on the at least one identifier to determine a real-time participant status based on an intelligence model accessed by the computing device. The computing device may choose an intelligence model to train with the at least one identifier and format the at least one identifier to train the intelligence model.

A conferencing system, in accordance with some embodiments, may have a sensor array positioned in a meeting space. An initial set of operating parameters is installed for the sensor array before detecting characteristics of the meeting space with the sensor array. Meeting participants in the meeting space are identified with the sensor array and a relationship strategy is generated with a computing device connected to the sensor array with the relationship strategy prescribing a relationship set of operating parameters for the sensor array to detect interpersonal relationships between meeting participants. Next, the computing device designates an initial relationship status to a pair of meeting participants in response to the activation of the relationship set of operating parameters for the sensor array. A context strategy is generated with the computing device that prescribes a context set of operating parameters for the sensor array to detect behavior of at least one meeting participant. The computing device may then assign identifiers to detected behavior of a meeting participant that describe meaning corresponding with the detected behavior. A conferencing strategy is generated with the computing device that prescribes a content set of operating parameters for the sensor array to collect audio content and video content from meeting participants with customized accuracy. The computing device then formats the identifiers to train at least one intelligence model.

Other embodiments of a conferencing system may position a sensor array in a meeting space with one or more video cameras. Meeting participants in the meeting space are identified with the sensor array before a relationship between two or more meeting participants is determined. The relationship is then utilized, along with one or more video data streams, to train at least one intelligence model.

These and other features which characterize embodiments of the present disclosure can be understood in view of the following detailed discussion and the accompanying drawings.

### BRIEF DESCRIPTION OF THE DRAWINGS

FIG. 1 illustrates an example conferencing environment in which various embodiments of the present disclosure can be practiced.

FIG. 2 represents portions of a meeting space that may be a part of the conferencing environment of FIG. 1 and utilized in accordance with some embodiments.

FIG. 3 represents aspects of an example conferencing system in which various embodiments may be employed.

FIG. 4 represents portions of a conferencing environment configured to execute various embodiments of a conferencing system.

FIG. 5 represents portions of a meeting space in which various embodiments of a conferencing system that may be utilized.

FIG. 6 is a block representation of a conferencing system that may be employed in a conferencing environment in accordance with assorted embodiments.

FIG. 7 represents a flowchart of a relationship routine that may be conducted in a meeting space with various embodiments of a conferencing system.

FIG. 8 represents a flowchart of a context routine that may be executed in a conferencing environment with a conferencing system in some embodiments.

FIG. 9 represents a flowchart of a conferencing routine that may be carried out with assorted embodiments of a conferencing system.

FIG. 10 represents portions of a sensor assembly that may be employed in a conferencing environment as part of a conferencing system in various embodiments.

FIG. 11 represents aspects of a multi-modal context system that may utilize various aspects of a conferencing system in a conferencing environment in accordance with some embodiments.

### DETAILED DESCRIPTION

Various embodiments of a conferencing system may optimize the detection of conference participant behavior, defining of detected behavior with relationship context, and teaching of an intelligence model with selected participant behavior. The use of a multi-modal sensing assembly may efficiently provide an accurate understanding of a conferencing environment and precise detection of participant behavior by controlling sensor settings and operational parameters. The detected activity from the multi-modal sensing assembly may then be intelligently parsed to determine the context of the detected activity and train at least one intelligence model with the parsed aspects, which may result in more efficient, and precise, future analysis of conferencing behavior. Additionally, a general AI or Video-LLM may be trained using both the traditional conferencing audio and visual information and the aforementioned parsed aspects, resulting in a more accurate, capable, or nuanced model.

The use of sensors may provide pertinent conferencing audio and visual information. For instance, sensors may be employed to detect the presence of conference participants to record accurate audio and visual output over time. A conferencing system may further employ one or more models to predict and/or react to participant behavior to capture and/or convey participant behavior accurately. The use of various sensors and intelligence models across different sites may allow for useful communication among participants as if they were in the same room.

However, an increase in communication capabilities with greater numbers of sensors and/or use of modeling to adapt conferencing system conditions may add complexity and increase risk of errors. For instance, the use of sensors to identify participants may delay the use of intelligence and modeling to set operating parameters for audio and/or video recording, processing, and transmission to other conferencing sites. The time delays caused by complex sensing systems may be compounded when participants leave, enter, or move within a space and sensors are not capable, or efficient, at accurately capturing audio and/or video content from one or more participants.

With these operational issues in mind, various embodiments of a conferencing system may utilize a multi-modal sensing array to efficiently understand a conferencing space and conferencing participants. Such understanding allows a conferencing system to collect information about participant behavior and activities that may be employed to assign context to detected participant actions. The accurate assignment of behavioral context then may be fed into a learning model to provide future intelligence about conferencing activity and participant interactions.

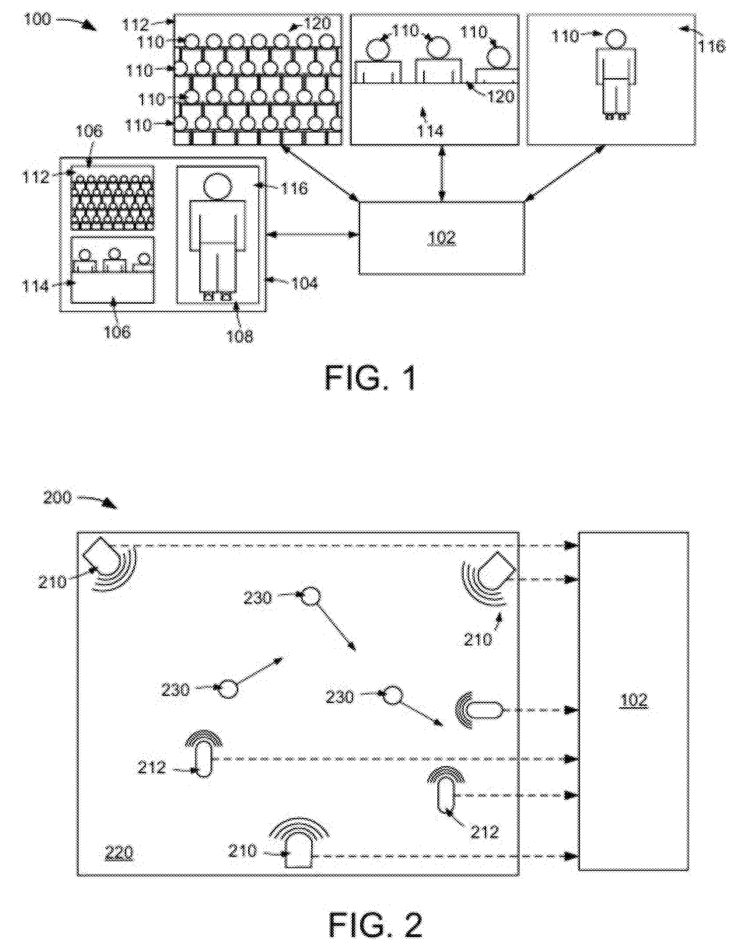

An example conferencing environment 100 is shown in FIG. 1. The conferencing environment 100 may experience assorted embodiments of the present disclosure. One or more computing devices 102, such as a desktop computer, laptop computer, tablet computer, or other programmable circuitry, may collect, organize, process, and distribute digital information to administer a virtual meeting with participants located at different physical locations. A computing device 102 may employ one or more processors, such as a microprocessor, controller, or other programmable circuitry, along with a memory, such as a volatile random access memory or non-volatile solid-state array, to generate a visual collection of digital data from assorted locations, as illustrated by virtual environment 104. An example computing device 102 may be an AVC core processor, such as the processor described in application numbers 17/893,107 and 15/975144, which are hereby incorporated by reference.

The generated virtual environment 104 may have any organization, theme, look, or arrangement, but some embodiments position different passive participants of a meeting in separate windows 106 while an active participant is presented in a larger window 108. It is contemplated that the computing device 102 alters the size of the various windows 106/108 as different participants become active or inactive through talking and/or activity. As such, the computing device 102 may change assorted aspects of the virtual environment 104 over time in response to detected conditions, such as who is talking, what is being discussed, or who is presenting information.

While a select number of different participant environments are displayed in FIG. 1, the computing device 102 may input any number, and type, of input feeds, as illustrated by solid arrows, and translate those feeds into the collective virtual environment 104. The non-limiting example meeting conveyed in FIG. 1 has a variety of different participants 110 physically located in different locations. It is noted that the virtual environment 104 may represent different participants physically located in a common location, such as an office building, auditorium, or boardroom. However, other embodiments utilize the computing device 102 to virtually bring together participants physically located in different cities, buildings, states, or countries.

One such physical location 112 may have high volume seating, such as a theater, classroom, or lecture hall, where participants 110 are relatively close and the group of participants 120 has a relatively high density. Another physical location 114 providing meeting participants 110 may have less density, as shown, such as a conference room, boardroom, or office. A single participant 110 may also be included in the meeting from a different location 116 without others being physically adjacent. It is noted that the assorted physical locations 112/114/116 may be equipped with any number, and type, of meeting equipment, such as microphones, cameras, and displays. Similarly, the virtual environment 104 can be displayed to any number of users in any type of format, such as a speaker, monitor, television, projection, augmented reality, or virtual reality alone or in combination.

Through the combination of the audio and/or visual digital content transmitted to the computing device 102 via wired and/or wireless signal pathways, the respective participants 110 can conduct simple or complex meetings. Yet, the use of multiple separate audio/visual equipment in different locations 112/114/116 may pose operational difficulties.

FIG. 2 illustrates aspects of an example conferencing system 200 that may be incorporated into the environment 100 of FIG. 1. As generally shown, a number of sensors 210 may be separated within a meeting room 220 to collect audio and/or video content from one or more participants 230. While sensors 210 are stationary, they may be tuned to collect accurate audio/visual content from one or more particular position within the meeting room 220. However, the dynamic nature of some conference meetings may result in a range of different activities by at least one participant, which is illustrated as solid arrows.

Although operating parameters of audio/visual content collecting sensors 210 may be adjusted over time to adapt to changing conditions, such adjustment may be slow, imprecise, prone to lag, and ignore other activity within a meeting room 220. In meeting situations that are particularly fast-paced where participants 230 move, shift, and gesture frequently, a conferencing system 200 may be inefficient in detecting identity and activity of participants 230 as well as detecting the location of participants 230 to direct the focus of one or more audio/visual content collecting sensors 210.

It is noted that the conferencing system 200 may employ any number and type of sensor 210 positioned at any location within the meeting room 220, but greater volumes of sensors 210 may produce an overwhelming amount of data that must be processed and understood before practical adaptations to operational parameters may be conducted. For instance, the use of environmental detectors 212 configured to sense aspects of participants 230 and/or the meeting room 220 without collecting audio or video content that is compiled by the computing device 102 of the conferencing system 200 to be transmitted to other conferencing sites may provide an understanding of the optimal operational parameters for the content collecting sensors 210, but at the expense of heightened data processing, storage, and implementation, which may degrade the meeting experience over time. Hence, the collection, transmission, and display of compiled conferencing content to other, remote conferencing sites may experience delays and lag that degrade the quality, and effectiveness, of a conference meeting.

In comparison to conferencing systems that utilize relatively simple combinations of content collecting sensors 210, such as optical cameras and microphones, some embodiments of a conferencing system 200 employ a variety of different sensors 210/212 to both understand the events of the meeting room 220 as well as accurately collect audio/visual content. As such, a conferencing system that employs stationary sensors 210 set to a single set of operating parameters, for instance, may be quick and accurate for a small range of operational conditions, such as stationary participants 230 that are speaking clearly and without changes throughout a meeting. In contrast, a more sophisticated conferencing system 200 may provide superior content collection and robust adaptations to changing meeting conditions over time, but may have degraded conferencing experience due to the occurrence of delays, lag, and buffering.

With relatively simple, or complex, conferencing systems, the inclusion of one or more learning models and/or intelligence may provide insight into operating parameters that may be adjusted to optimize content quality, processing time, and overall conferencing experience. However, the learning/intelligence model must provide accurate information to allow for optimal reactive and/or proactive, adaptations to various sensor 210 operating parameters in response to detected meeting room 220, and participant 230, conditions and activity. Hence, models and intelligence need to be trained with information and conditions over time that promote accurate identification of current conferencing conditions and prediction of future participant behavior.

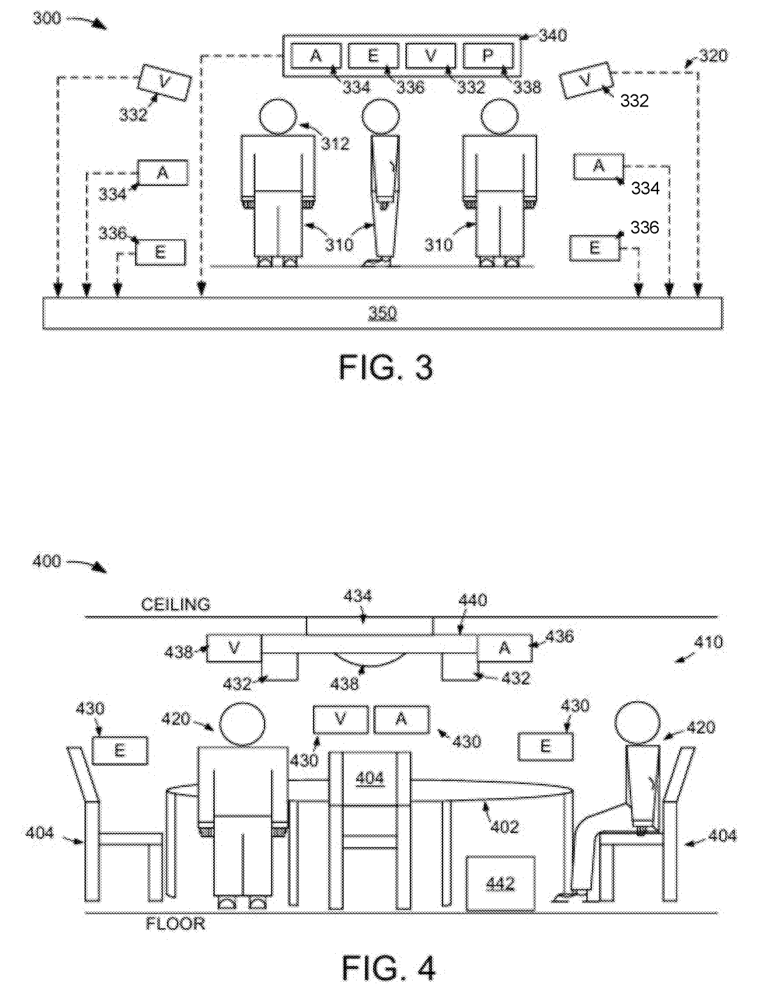

FIG. 3 conveys a line representation of portions of a conferencing environment 300 where multiple participants 310 engage in activities and interactions that are detected by a conferencing system 320 operated in accordance with various embodiments in a. The conferencing system 320 may be tuned to detect a face 312 of a participant 310, which may be utilized to collect audio and/or video content for transmission to other, remote conferencing sites and/or to identify the position and identity of a participant 310. For instance, any number, and type, of sensor 330 may be active concurrently, or sequentially, to detect the presence of participants 310, recognize a participant’s face 312, and/or measure where a participant 310 is positioned in a meeting space, such as a conference room, lecture hall, arena, stadium, or office. As shown, but not limiting, the sensors 332/334/336 may be respectively dedicated to collecting audio (A) data, video (V) data, or environmental (E) data that is processed by a local processor 338, in the case of a local sensor assembly 340 and/or a processor of a connected computing system 350.

No matter the number, and type, of sensor 330 employed by a conferencing system 320, the useful collection of information and audio/visual content is complicated when one or more participants 310 move or speak at the same time. That is, no number, or position, of sensor 330 may efficiently detect the identity, activity, and position of multiple participants 310 while accurately recording audio/visual content when the participants 310 are moving and/or talking at the same time. Indeed, a conferencing system 320 may be particularly error prone when acoustic sensors are employed to detect the identity and/or position of a participant 310 that is talking over another participant 310. The accurate detection of participant behavior is also difficult when meeting participants 310 move about a meeting space.

It is noted that participant 310 behavior may be characterized as actions, such as gestures, movements, vocal tone, speed of speech, and expressions, that may, or may not, accompany audible sound. Some embodiments of a conferencing system 320 utilize one or more sensors 330 in a meeting space to detect and track the location of a meeting participant 310. Such location detection and tracking over time may be employed by a local, or remotely connected, computing system 350 to understand the actions of the participant 310, correlate the participant 310 with a known profile or set of known behavioral characteristics, and understand the real-time feelings and/or emotions of a participant 310.

However, accurate identification and tracking of a participant 310 may not provide sufficient behavioral context to properly train a learning/intelligence model. That is, recording the facial expressions and gestures of a participant 310 in isolation may not present context, or may present incorrect context, with respect to the participant’s relationship with others in the meeting. For instance, an insult and angry facial expression may present incorrect emotional, behavioral, and contextual cues when done sarcastically, or as a joke, alone or in relation to another meeting participant 310. Hence, various embodiments of a conferencing system 320 are directed to utilizing a sensor array to accurately detect a participant’s location, identity, actions, and behaviors as well as relationships between participants 310 in the same meeting space and across different meeting spaces joined as part of a single conference meeting.

It is contemplated that to provide context to the behavior and/or actions of a meeting participant 310, the assorted sensed aspects of a participant 310 are parsed by a connected computing system 350 into information that indicates and/or confirms the relationship between participants. Through the detection of participant 310 behavior, position, and orientation over time by one or more sensors 330, the computing system 350 may speculate, alter, and subsequently confirm the existence of a relationship, such as a passive relationship or an active relationship. For instance, a passive relationship may be characterized as a submissive position relative to another participant 310 while an active relationship may be characterized as a dominant position relative to one or more participants 310.

The identification of passive and active relationships among the participants in a meeting space may allow the computing system 350 to more efficiently, and/or accurately, determine the type, and degree, of emotional relationship between participants 310. As greater volumes of participant behavior, actions, and movements are gathered by the system sensors 330 after the system 320 has determined, or speculated, about the relationship between the participants 310, various identifiers, characterizations, and descriptors may be assigned to the respective participants 310 to aid in determining context of future participant 310 behavior.

For instance, an identified active relationship between participants 310 may render, over time, a determination that sarcasm is often employed and provide context for characterizing the emotional state of a participant 310 in the future. As another non-limiting example, a passive relationship for a participant 310 may be employed to interpret future participant 310 movement, gestures, and orientation during a meeting with emphasized meaning, compared to verbal tone, speed, and volume, to determine the real-time emotional state of the participant 310.

In accordance with various embodiments, the intelligent collection and processing of meeting activity allows for the accurate identification of various relationship, which indicate which detected participant actions, behaviors, and activities to ignore, or emphasize, to accurately understand of how a participant feels and how the participant will likely behave in the future. With the accurate real-time identification of inter-participant relationships, real-time emotional states, and likely future participant 310 behavior, meeting parameters may be actively, and/or proactively, customized to maintain optimal content collection despite changing participant 310 behavior.

FIG. 4 illustrates a block representation of portions of a conference meeting space 400 that may be part of a conference environment and utilizes a conferencing system 410 in accordance with various embodiments. It is noted that the conferencing system 410 may be wholly located within the meeting space 400 or may be a combination of local hardware and remotely connected network components, such as hardware that may execute assorted software to provide processing, data storage, content compilation, encryption, and model training.

As generally illustrated, the meeting space 400 has a variety of furniture in which participants 420 may occupy, engage, or move over the course of a meeting. Although not required, some furniture may be stationary items 402, such as a table, desk, or screen, while other furniture may be mobile items 404, such as chairs, displays, and devices located on stationary items 402. The meeting space 400 may further be outfitted with a number of separate sensors 430 that detect predetermined aspects of the meeting space 400 and the participants 420. The respective sensors 430 may be configured to detect conditions and aspects of the room as well as collect audio and/or visual content that is employed to join other, remote conferencing sites into a single conference meeting, as generally illustrated in FIG. 1. It is noted that the various sensors 430 may be dedicated to detecting a particular aspect of the meeting space 400 or may be configured to collect meeting content along with detection of meeting conditions.

While participants 420 are stationary during a meeting, sensors 430 and content collection may be able to provide optimal audio and visual with a single set of operating parameters. For instance, an initial, pre-meeting setup operation may result in a set of operating parameters that provide optimal collection of audio and visual content for selected locations the meeting space 400, such as zoom, focus, lighting, beam-forming, filtering, amplification, and other digital processing parameters. Such selected locations may be, for instance, a likely location of a participant’s head when seated at stationary furniture 402 or a video image of a half-body of a standing participant giving a presentation next to a screen, board, or display.

However, when participants 420 move, as indicated by solid and segmented arrows, even if the movement is within a single meeting space 400, existing operating parameters may end up being sub-optimal. That is, audio and/or video recording parameters for a selected position in the meeting space 400 may not provide accurate meeting content, such as audible speech or speaking participant 420 in a video frame, when a participant 420 ducks, tilts, shifts, initial operating parameters for audio and/or video recording may be inefficient, unclear, or otherwise sub-optimal.

Accordingly, a sensor assembly 440 may be employed as part of a conferencing system 410 to provide general, and specific, understanding of the contents and events of the meeting space 400. The sensor assembly 440 may have any number, and type, of sensors 432 that is active continuously, sporadically, routinely, or in response to specific operational triggers, to monitor one or more aspects of the meeting space 400. For instance, the sensor assembly 440 may have optical, acoustic, CO₂, and thermal sensors 432 that collect data indicating at least the number of participants 420, location of participants 420, actions of participants 420, orientation of participants 420, facial gestures of participants 420, and position of furniture 402/404 within the meeting space 400.

In accordance with various embodiments, the sensor assembly 440 may employ one or more computing aspects 442, such as a microprocessor, system on chip (SOC), integrated circuit, or other programmable circuitry, that may collect, filter, process, and combine the information collected by the assorted sensors 432 to understand the real-time current conditions of the meeting space 400. It is noted that the computing aspects 442 may be local to the meeting space 400 and/or remotely connected to the meeting space 400, such as, for example, a cloud computing device or computing device located in another location.

With the inclusion of the local processor 434, a conferencing system 410 may operate with concurrent and parallel data streams that monitor real-time meeting space 400 conditions while collecting, combining, and transmitting audio/visual content to other environments of a live conference meeting. The dedication of meeting space 400 evaluation with the sensor assembly 440 may minimize operational lag, delays, and sub-optimal meeting content collection from A/V sensors 430 by simplifying the processing burden on a supplemental conferencing system processor, which may be local or remotely located relative to the meeting space 400.

As a non-limiting example, the sensor assembly 440 may track a two-dimensional position of participants 420 and furniture 402/404 within the meeting space 400 that is translated into a three-dimensional position by the local processor 434 to provide a greater understanding of what operating parameters are best to record audio and/or video content from the respective participants 420. The sensor assembly 440, in other embodiments, may monitor the activity and/or behavior of participants 420 over time, which may be interpreted by the local processor 434 into constituent elements, tasks, actions, movements, and gestures that allow for the subsequent determination of inter-participant relationships as well as the assignment of context to assorted participant 420 behavior and activity detected during the course of a meeting.

In some embodiments of the sensor assembly 440, the various computing components and sensors are packaged in a single housing that is structurally configured to fit on a tabletop. As illustrated in FIG. 10, a sensor assembly 1000 may have a cylindrical housing 1010 that houses at least one camera, microphone, and speaker atop a table 1012. The sensor assembly 1000 may further have a power source, data memory, and processing components packaged within the housing 1010.

The sensor assembly 1000 may be employed as a stand-alone device that enables conferencing between remote meeting spaces. As such, the camera and microphone may operate to capture audio and video meeting content while the speaker may convey audio from other meeting spaces and participants. Various embodiments of the sensor assembly 1000 employ a 360-degree camera 1020 and speaker 1030 that may, respectively, be static, or dynamically rotate, to capture video and/or audio content from around a meeting space. Other embodiments of the sensor assembly 1000 employ multiple cameras that activate in accordance with assigned operating parameters to capture meeting video content efficiently and accurately.

While the sensor assembly 1000 may provide stand-alone conferencing by providing all the hardware, and processing, to conduct a conferencing meeting with other, remote meeting spaces, it is contemplated that the sensor assembly 1000 may be employed as an expansion peripheral to a conferencing system, such as system 410 of FIG. 4. As a peripheral appliance, the sensor assembly 1000 may provide supplemental information, audio content, and/or video content to a conferencing system. In some embodiments of the sensor assembly 1000, the constituent camera and/or microphones may be selectively employed as participant sensors instead of audio/visual content recording components. That is, a camera 1020 may be selectively used to detect participant movement, orientation, behavior, or speech while other camera and microphone aspects of a conferencing system record the audio and video meeting content that is compiled and transmitted to other meeting spaces.

The sensor assembly 1000 may, in various embodiments, be connected to other sensor assemblies 1000 within a meeting space, such as on opposite ends of a table or proximal a presentation display. The combination of multiple separate sensor assemblies 1000 may further provide additional processing capabilities and connectivity to a meeting space. Hence, the sensor assembly 1000 may provide wired and wireless connectivity for other peripheral system devices, such as displays, speakers, and sensors, which allows for a diverse variety of installation configurations. For example, the sensor assembly 1000 may be wirelessly connected to a computing device of a conferencing system while connected to a speaker or display with a wired cable that provides electrical power and/or data.

Embodiments of the conferencing system 410 may provide auto-framing and auto-tracking of a participant 420 in a video stream, which allows a camera sensor 430/432 to zoom-in and follow a participant 420 using that sensor’s own video data. Sound from a multi-element microphone sensor 430/432 can be used to locate a sound source and beam-form those same elements to focus reception on that sound. Other embodiments may combine audio and video sensing capabilities in a single, co-located sensor 430/432 to enhance the ability to auto-track a participant 420. As such, a conferencing system 410 may use the same sensor(s) 430/432 for the identification, detection, and tracking of the participant 420 of interest and then to collect the useful data on that participant 420.

While various sensors 430/432 are focused on the participant 420 of interest, different sources of interesting data, information, and A/V content may be missed. For example, a second participant 420 may concurrently speak or an additional participant 420 may enter the meeting space 400. Hence, conferencing systems 410 that do not utilize the sensor assembly 440 may experience incorrect audio content and/or video content, particularly in larger meeting spaces 400, such as auditoriums, concert halls, ballrooms, and arenas, due, in part, to a lack of a proper frame of reference or understanding of the extent and/or aspects of the meeting space 400 that would allow intelligent decisions of which content sensor 430 to activate and what operating parameters to execute.

It is contemplated that some embodiments of a conferencing system 410 use a separate dedicated sensor 430 or a multi-sensor assembly 440 for identification and tracking of all the participants 420 and one or more separate sensors 430 to collect the useful data on the participant 420, such as a camera and a microphone for video and video content collection. Such a conferencing configuration may be especially advantageous, for example, when there are multiple cameras and microphones present in a relatively large meeting space 400, when there are multiple participants 420 in a space 400 and by necessity the camera or microphone used to collect data from one participant 420 to the next must be switched or the settings changed, and/or when a participant 420 may be moving such that it is useful to switch the camera or microphone that is collecting the data on the moving participant 420.

In accordance with various embodiments, the sensor assembly 440 may be composed of multiple microphone sensor 436 elements and a co-located camera sensor 438 with fisheye lens, mounted to the ceiling of the meeting space 400. The assorted sensors 432/436/438 of the sensor assembly 440, along with the local processor 434, may provide efficient and accurate location of human subjects using a combination of sound source location and facial/body recognition, which may instruct the conferencing system 410 the location of the human subjects within the meeting space 400 as well as relative to the furniture 402/404 located in the meeting space 400.

Operational embodiments of the sensor assembly 440 may direct beam-forming microphones and cameras onto detected human participants 420 and/or process video streams, such as auto-framing, and/or process audio streams, based on the location of the human participants 420 in a common reference frame used by all the sensors 430 in the system 410. It is noted that the local sensor assembly processor 434 may operate individually, or concurrently, with one or more processors of the conferencing system 410 to provide seamless understanding of the real-time conditions of a meeting space 400 as well as the optimal audio and video collection parameters for various sensors 430. The local sensor assembly processor 434 may implement a mathematical algorithm and AI pattern recognition to identify and verify a room’s extents, a number human subjects from video, a partial location solution (2D) of a human subject’s location from video relative to the sensor assembly 440 and/or to the room extents, a source location of sounds relative to the sensor assembly 440, and a location of a human subject (3D) that combines sound location with human subject identification/location from video.

The sensor assembly 440 may include one or more forms of intelligence, such as neural net or pre-trained pattern matching algorithms, for video processing and/or sound processing for identification of walls, objects, faces, furniture, speech, and noise. The sensor assembly 440, in some embodiments, may include lights, lasers, and/or mirrors, such as selectively active light emitting diodes (LED) or other such optically identifiable markers, to allow the conferencing system 410 to locate the sensor assembly 440 relative to its other system sensors 430, such as cameras and other sound equipment, which allows for the creation of a common reference frame. Alternatively, the sensor assembly 440 may be used to optically locate the other system sensors 430, such as cameras and other sound equipment, to create a common reference frame. The sensor assembly 440, in another embodiment, may be stationary with other conferencing system 410 components in fixed positions that allow for measurements to create a common reference frame.

It is contemplated that the sensor assembly 440 may be used as an occupancy sensor alone, or in combination with other sensors 430 and/or sensor assemblies 440, particularly in relatively large meeting room 400 sites. Accordingly, a sensor assembly may be composed of multi-element microphones and one or more cameras that are co-located and held in fixed positions, and orientations, to one another to allow correlation of detected optical data and sound data to locate one or more human subject’s physical position relative to the sensor assembly. Embodiments of the sensor assembly may determine the physical location of one or more human subjects by identifying humans in a camera video, locating the human’s two-dimensional position relative to the sensor assembly, detecting the three-dimensional position of at least one sound source using relative time-of-flight analysis on the sounds detected by microphone elements of the sensor assembly, using the sound source location to refine the position of human speakers using the known orientation and position of the camera relative to the microphone elements.

Various embodiments of a conferencing system utilize a sensor assembly with multi-element microphones and one or more cameras that are co-located and held in fixed positions and orientations, along with a local processor, to implements an algorithm to determine the physical location of one or more human subjects within a meeting space 400 by identifying humans in the camera video, locating the human’s two-dimensional position relative to the device, detecting the three-dimensional position of at least one sound source using direction-of-arrival analysis on the sounds detected by the microphone elements, and using the sound source location to refine the position of human speakers using the known orientation and position of the camera relative to the microphone elements.

While not required or limiting, the sensor assembly 440 may be structurally configured with all microphones positioned along a single plane, which may be characterized as co-planar. The microphone sensors of a sensor assembly 440 may be co-planar or offset from one another in multiple separate planes, such as arranged in an approximate circular pattern around the camera. At least one camera sensor 432 of a sensor assembly 440 may employ a fish-eye lens. Any number of sensor assemblies 440 may be utilized in a conferencing system 410 to employ imaging cameras and beamforming microphones to determine the position of human subjects, control the orientation and/or focus of the imaging cameras as well as the beamforming microphones, and control the processing of the imaging camera’s video stream.

A conferencing system 410, in some embodiments, may determine the sensor assembly’s location relative to the other conferencing system components optically using one or more cameras to create a unified coordinate system. A sensor assembly 440 may be utilized, in accordance with other embodiments, to employ an algorithm to find the physical location of one or more human subjects in a meeting space 400 by identifying humans in the camera video, to locate the human’s physical position relative to the sensor assembly 440, to detect the three-dimensional position of sound sources using direction-of-arrival analysis on the sounds detected by the microphone elements, to refine the position of human speakers with sound source locations using the known orientation and position of the camera relative to the microphone elements, which may then be used to determine how other imaging cameras and beamforming microphones can be aimed and focused so as to capture images and sounds of the human subjects

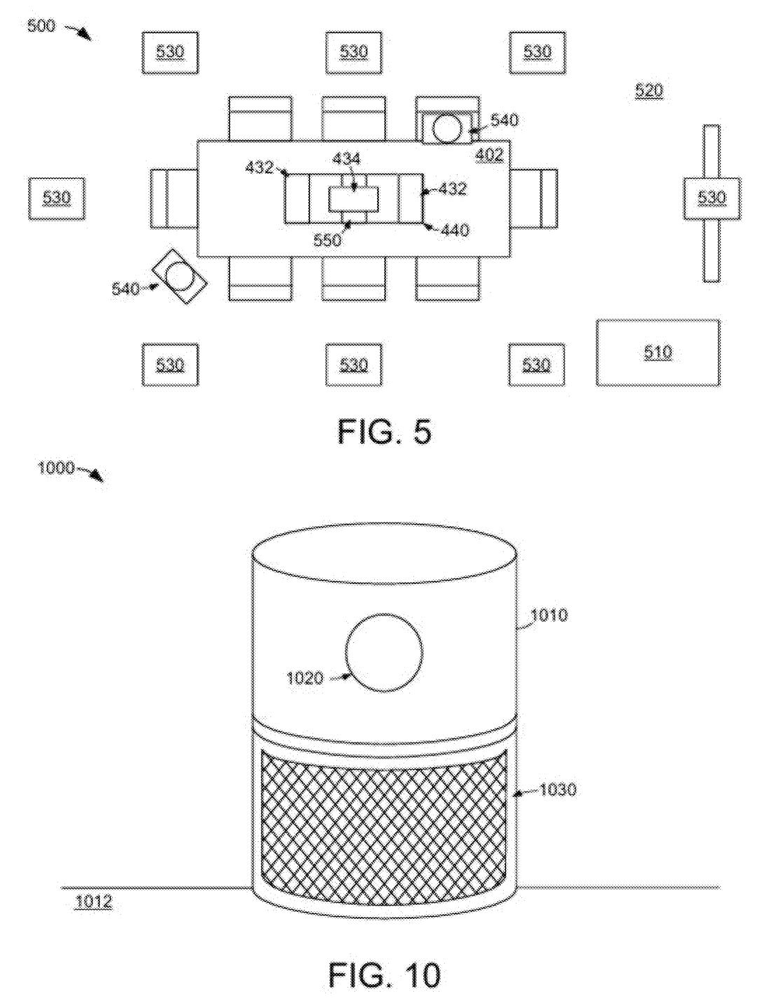

FIG. 5 illustrates aspects of an example conferencing environment 500 in which the sensor assembly 440 of FIG. 4 may be employed as part of a conferencing system 510. With the ability to efficiently understand the conditions, objects, and actions of a meeting room 520, the information rendered from such understanding may be utilized to optimize the operating parameters of various content collecting sensors 530 over time.

It may be desirable in unified communications and collaborations (UCC) conferencing applications to provide video feeds of individual participants 540 in the meeting room 520, as opposed to a long single shot of the entire environment 500. Such audio/visual content collection with individual sensors 530 may help with the overall quality of a video conference experience and may drive parity for remotely connected participants, as conveyed in FIG. 1. Embodiments of the conferencing system 510 may set operating parameters of an A/V sensor 530 to frame individual participants 540. For instance, portions of video may be cut, or cropped, from a fixed focus camera feed. This technique, however, requires that all participant subjects face a camera sensor 530 and may still suffer from low resolution.

Another embodiment may employ a pan-tilt-zoom (PTZ) camera sensor 530 to zoom-in and focus on a single participant 540, which may involve the assistance of artificial intelligence (AI) algorithms for facial recognition and/or behavior prediction. While the video from the PTZ camera sensor 530 may offer superior video quality, the sensor 530 may suffer from the problem that when zoomed-in, the camera sensor 530 loses access to information about the presence and location of all other items and participants 540 in the meeting room 520.

In embodiments of the conferencing system 510 that employ a combination of a fixed-focus camera sensor 530 and one or more PTZ camera sensors 530, a sophisticated variety of operational characteristics may be provided. That is, the fixed-focus camera sensor 530, which may be characterized as a “conductor” camera, provides the conferencing system 510 with situational awareness including the presence and location of all objects and participants 540 in a meeting room 520. Such situational awareness allows for the PTZ camera sensor 530 to selectively, and intelligently, zoom and focus to optimize video from individual participants 540.

Additional sensors 530, such as direction-of-arrival sensing microphone, might be leveraged to complement other camera sensors 530 to determine which subjects to focus on as well as other operational parameters, such as resolution and zoom. It is contemplated that intelligence, and/or learning models, may provide additional capabilities of infinite variety to one or more system sensors 530 as well as central processing, to further select the optimal audio and visual content collection parameters without generating superfluous data collection that may strain, or delay, the compilation, transmission, and/or playback of meeting content in other meeting sites, as generally shown in FIG. 1.

Assorted embodiments propose a multi-modal context sensor 550 that can capture and process both sound and video signals from a conference meeting room 520, which allows the sensor 550 it to operate as a ‘super’ conductor camera. By providing a 180-degree field of view from a ceiling mounted, central location, the context sensor 550 can maintain the best possible location and presence data for all human participants 540 in the meeting room 520. By combining video and sound capture and processing, the context sensor 550 can accurately direct other camera sensors to precisely zoom-in and focus on specific human participants 540, determine how fix-focus camera feeds should be cut to frame individual participants 540, and/or focus microphones onto specific participants 540.

By centrally locating certain AI video processing functions in a sensor assembly 560, the conferencing system 510 could leverage various camera sensors 530 with less supplemental sensors 530 and less computing capabilities, such as processing speed and application of AI and other models, than otherwise necessary, which may enhance multi-camera room solutions. Accordingly, the multi-modal context sensor 550 can offer a superior video conferencing experience by providing accurate, multi-participant 540 tracking while allowing for un-restricted participant 540 location, position, and movement within a meeting room 520 that may be recorded with high quality, individual subject video feeds and focused microphone audio.

It is noted that the multi-modal context sensor 550 may be differentiated from conferencing system that utilize individually controlled, or uncoordinated, cameras that may produce lower quality, or inconsistent, video output. The multi-modal context sensor 550, in some embodiments, can enable the use of less expensive PTZ cameras compared to competitive solutions while maintaining sophisticated, accurate video content collection. The multi-modal context sensor 550, in addition, may be retrofit to existing arrays of sensors 530 to coordinate multiple devices, sensors, and other such conferencing features to provide efficient, accurate collection of pertinent conferencing video content.

Through the use of a context sensor 550 as part of a conferencing system 510, an understanding of the positions, actions, and behavior of various aspects of a meeting room 520 provides an ability to optimize operational parameters of content collection sensors 530 as well as to prevent superfluous data/content from degrading the processing capabilities of the conferencing system 510. The position and operation of a context sensor 550 is not limited to a particular configuration, but may be integrated into a conferencing system 510, in some embodiments, to allow for quick and precise interpretation of data from other sensors 530 to identify the relationships between participants 540, context of participant 540 behaviors, and behavior aspects that may be pertinent to training AI and/or other learning models.

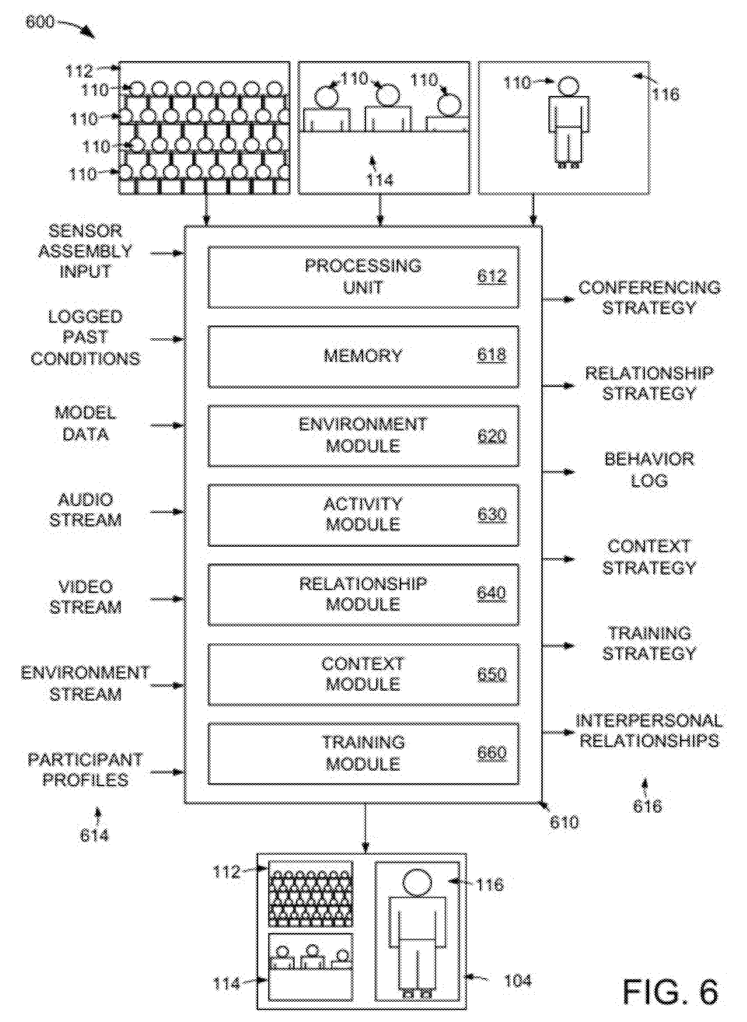

FIG. 6 conveys a block representation of aspects of a conferencing system 600 configured and operated in accordance with various embodiments to provide intelligent collection of data, audio, and video to provide optimized compiled meeting content as well as detected contextual behaviors that may be utilized to train and improve one or more, new or existing models. It is initially noted that the conferencing system 600 may consist of any number, and location, of components throughout a distributed network and separate meeting sites. For instance, the conferencing system 600 may be isolated to a single meeting room, such as room 520 of FIG. 5, or distributed among separate meeting rooms with redundant, or supplemental, hardware that executes matching, or dissimilar, software to produce an accurate and efficient virtual representation of the assorted content of the respective meeting sites.

As a non-limiting example, the conferencing system 600 may be isolated to a sensor assembly, such as assembly 440, while other embodiments may employ physically separate hardware, such as circuitry present in different cities, countries, time zones, or continents, to provide assorted embodiments that optimize virtual conference collection, generation, and model training. Hence, the block representation of a computing device 610 in FIG. 6 does not, necessarily, correspond with a single physical housing in which circuity corresponding with the various operational aspects are housed.

The computing device 610 may correspond with the computing device 102 of FIG. 1 and have a processing unit 612 that provides control and data processing hardware. The processing unit 612 may comprise a microcontroller, system-on-chip, application specific integrated circuit, or other programmable circuitry, which may operate alone, or with other circuitry of the computing device 610 to translate input information 614 into various strategies and output information 616. The processing unit 612 may utilize one or more memories 618 to temporarily, or permanently, store information, settings, and data that contribute to the recording of a meeting, translation of the meeting into a virtual environment 104, and optimization of the meeting recordings over time, as facilitated by the processing unit 612.

Although the computing device 610 may have any number of connections and input any volume, and type, or information and data, various embodiments utilize camera streams, microphone streams, and environment sensor streams as input information 614 along with past logged activity, known meeting characteristics, such as furniture dimensions, meeting room specifications, and sensor detection zones. The assorted input information 614 may be employed concurrently, or sequentially, to generate strategies, as shown in FIG. 6, that prescribe actions and/or instructions that allow for efficient optimization of meeting content, determination of participant relationships, and contextual selection of participant behavior to train a intelligence/learning model.

The computing device 610 may selectively utilize an environment module 620 to contribute to the generation of a conferencing strategy that prescribe proactive and reactive alterations to meeting content collection operating parameters to provide accurate meeting representations based on the position and activities of meeting participants. The environmental module 620 may employ any number, and type, of sensors of a conferencing system to detect and measure meeting participant position, orientation, and activity within a meeting space over time. The environmental module 620 may further determine a two-dimensional position of a meeting participant within a meeting space, which may then be translated by the computing device 610 into a three-dimensional plot of assorted portions of the meeting participant, such as the face, torso, or hands.

Such three-dimensional tracking of participants may allow for increased resolution for detection of participant actions, gestures, activities, and behavior over time. The increased resolution of tracking a participant’s face, torso, and hands, for instance, may allow for heightened understanding of the behavior and activity of a participant. For instance, concurrent detection of a participant’s face and hands may allow for accurate determination of various gestures that indicate a participant’s emotions and relationship to other participants. It is noted that any number, type, and location of sensor may be employed to detect and measure the actions and behavior of assorted aspects of a participant over time. As an example, different, or matching, optical sensors may operate with acoustic, mechanical, and/or carbon dioxide sensors to detect actions in accordance with assigned three-dimensional coordinates from the computing device 610.

The environmental module 620, in some embodiments, monitors the relative position and orientation of the assorted objects in a meeting space over time. For instance, environmental, acoustic, and/or optical sensors may detect where various furniture and participants are located relative to one another, which may involve the processing unit 612 comparing the two-dimensional, or three-dimensional, coordinates of selected aspects of a meeting space over time. Through the use of the environmental module 620 to understand the dimensions and contents of a meeting space as well as the positions and orientations of objects, furniture, and participants within the meeting space, the computing device 610 may generate, and alter, a conferencing strategy that sets out how a conferencing system is to operate with the various constituent sensors and meeting content collection aspects.

With the evaluation and tracking of the contents of a meeting space with the environment module 620, other sensors of a conferencing system may be directed to detect the activity of the assorted meeting participants, as directed by the activity module 630. That is, the environmental module 620 may utilize less than all the processing and sensing capabilities of a conferencing system, such as the sensor assembly 440 of FIGS. 4 and 5, to allow other processing and sensing capabilities to be employed to detect the activity of participants. The dedication of some sensors of a conferencing system to detecting, tracking, and processing assigned characteristics, such as participant position and orientation, allows for other sensing aspects of the conferencing system to be activated with operating parameters set by the activity module 630 to efficiently monitor aspects of the assorted meeting participants, such as hands and face, to provide the computing device 610 with information at least about the actions, behaviors, and gestures exhibited by participants present in a meeting space.

In accordance with various embodiments, the activity module 630 may log sensed actions, behaviors, and gestures of participants and subsequently assign specific identifiers that may be utilized by the computing device 610 to understand the real-time status of meeting participants. For instance, the activity module 630 may detect gestures and behaviors of participants that assign one or more identifiers, such as angry, happy, frustrated, emphatic, annoyed, playful, and sarcastic, to participant behavior, such as talking, presenting, listening, and taking notes. The accurate detection of participant gestures and behaviors, along with the corresponding assignment of identifiers by the activity module 630, may trigger one or more operational parameters of the conferencing strategy to collect audio and/or video content with optimal accuracy.

As a result of the activity of meeting participants being stored as a behavior log to allow for accurate and efficient characterization by the computing device 610, a relationship module 640 may determine interpersonal relationships between participants. It is contemplated that the relationship module 640 may assign a predetermined interpersonal relationship between known meeting participants. In such situations, the relationship module 640 may conduct one or more tests, observations, and gesture tracking to verify that a predetermined relationship remains valid. The relationship module 640 may conduct any number, and type, of evaluations of participant behavior and activity over time to determine the interpersonal relationship between participants.

For situations where the relationship between meeting participants is unknown, or not verified, the computing device 610 may utilize a relationship strategy to speculate as to how the participants know, treat, and behave with respect to one another. The relationship strategy may be generated, and updated over time, by the computing device 610 with criteria, tests, policies, and/or rules that provide efficient determination, or confirmation, of the interpersonal relationship between meeting participants. Use of a relationship strategy with preestablished guidance to efficiently determine an interpersonal relationship contrasts the processing unit 612 simply assigning a default relationship that is altered over time in response to observed meeting participant behavior. That is, the relationship strategy may provide a more accurate initial relationship assignment than a default relationship due to existing rules and policies that react to detected participant characteristics, such as position within a meeting room, vocal tone, speech speed, speech intonation, and gestures.

By employing the relationship strategy, the computing device 610 may have less iterations over time to arrive to arrive at a verified interpersonal relationship, which reduces the computational complexity and time to reach an actual relationship determination, compared to using a single iterative process from a default initial relationship assignment. It is noted that the relationship strategy is not limited to a particular set of rules or policies and may prescribe any number and type of sensed conditions and sequential observations with sensors of a conferencing system to efficiently arrive at a confirmed interpersonal relationship between meeting participants, even if the participants are not in the same meeting space.

As a non-limiting example, the computing device 610 may initially assign a relationship status based on known participant characteristics, such as an existing behavioral profile or observed participant behavior, and subsequently utilize sensed participant conditions, such as specific mouth or hand gestures, prescribed by the relationship strategy to refine the initial status to a verified interpersonal relationship. The ability to intelligently react to meeting participants with prescribed sensor activity and/or rules may arrive at a confirmed interpersonal relationship that may be employed by the computing device 610 to interpret actions, speech, and behavior of a participant with context that provides proper training of intelligence/learning models as well as indications of future participant behavior that may trigger an alteration of meeting content collecting sensors.

With the capability of efficiently and accurately determining the interpersonal relationships between various meeting participants for specific, or general, subject matter, a context module 650 may intelligently assign context to participant behavior and activities to determine the real-time emotional state of a meeting participant. Through the understanding of the emotional status of participants during a meeting, the computing device 610 may ignore, or emphasize, sensed participant behavior, actions, and activities to optimize operational meeting conditions. For instance, the context module 650 may translate sensed meeting conditions with respect to relationship to ignore/emphasize behavioral identifiers to accurately interpret the real-time status of a meeting. As a practical example, a determination, by the computing device 610, of a subservient relationship between participants prompts the ignoring of facial gestures from triggering a change in microphone and/or camera operational parameters, such as gain, resolution, zoom, or applied digital filter.

While the context module 650 may perform sensor activity, such as changing sensor operational parameters, activating sensors, deactivating sensors, and supplementing with additional processing capability, in response to detected meeting conditions, other embodiments of the context module 650 may generate and maintain a context strategy that proactively prescribes sensor activity corresponding with operational triggers. For instance, a context strategy may prescribe a number of meeting participants while activating additional content recording audio and/or visual sensors. Another non-limiting instance of a context strategy may prescribe panning, zooming, and/or tilting of a camera and/or microphone in response to detection that a meeting participant has changed position, such as standing up or sitting down.

As a result of the context strategy altering one or more sensors upon detection of a prescribed operational trigger, the behavior of the assorted meeting participants may be efficiently, accurately, and completely detected by the sensors of the conferencing system. Such adaptive participant behavior detection ensures that the sensed participant actions, gestures, speech, and activity, which may be characterized generally as behavior, may be correctly characterized by the computing device 610 into contextual identifiers. It is contemplated, but not required, that the context strategy proactively sets rules and policies that aid in the efficient characterization of meeting participant behavior into contextual identifiers.

A contextual identifier is not limited to a particular descriptive term, word, or phrase, but may precisely describe some, or all, of the behavior of a meeting participant. For instance, a behavior may generally be described as “quiet” or “angry” while the context module 650 may generate identifiers that specifically describe the participant’s body language, facial gestures, hand gestures, speech patterns, and movement history. With the derivation of identifiers from detected participant behavior, the context module 650 may learn, over time, to predict participant behavior based on detected conditions. The parsing of general behavior into contextual identifiers additionally allows for the efficient and accurate training of intelligence/learning models, as directed by the training module 660.

The multitude of contextual identifiers, in isolation, may not provide efficient model training without processing from the training module 660. As such, inserting individual contextual identifiers into a model may create complexity and false conclusions unless the contextual indicators are formatted by the training module 660 in accordance with a training strategy to properly convey the meeting, and participant’s, condition during the identifiers that caused the recorded result. That is, a training strategy may prescribe predetermined formatting for various different participants, behaviors, meeting conditions, and participant reactions.

The availability of predetermined formatting and filters for assorted meeting and participant activities and behaviors allows the training module 660 to employ contextual identifiers seamlessly and without degrading the operation or performance of the sensor array and conferencing system, as a whole. The training module 660, in some embodiments, may employ a variety of different models, such as regression, decision tree, K-means, clustering, and naïve bayes, to sensed data to characterize, determine, and assign identifiers, relationships, and corresponding operational parameters for one or more conferencing system sensors.

With the accurate detection of assorted aspects of a meeting space, participants, and meeting content with the sensors of a conferencing system, the assorted strategies generated by the computing device 610 may be individually, sequentially, or concurrently executed to alter the operating parameters, conduct measurements, and/or manipulate how meeting content is digitally conveyed. In addition, the accurate detection of assorted aspects of a meeting, and meeting space, may allow for the collection, and analysis, of meeting metrics in accordance with an analytics strategy generated, and executed, by the processing unit 612.

Accurate aspect detection is of particular value when used along with video and audio data for training AI or other models.

It is noted that a variety of different metrics may be accumulated and organized by the processing unit 612, as directed by one or more analytics strategies. While not required or limiting, sensed speaker activity, and meeting participation, may be graphically conveyed by a pie chart. The overall time a meeting participant speaks may additionally be tracked and conveyed in timeline format. An analytics strategy may prescribe the determination, and tracking, of whom participants communicate with the most. For instance, a conferencing system may track whom a participant verbally talks to most often, looks at most often, or gestures to most often, which may be conveyed graphically in a variety of manners, such as arrows, tile colors, or paired shaped.

Through the prescribed logging, computations, and organization of meeting metrics, in accordance with the analytics strategy, aspects of a conference meeting may be better understood, and later utilized. As a non-limiting example, meeting information may provide insight for meeting participants in how to conduct future meetings, such as whom to include in conversations, whom to limit speaking time, and where participants should be seated. The meeting information from an analytics strategy may further be employed by the training module 660 to create input for one or more intelligence/learning models to improve the accuracy, and perhaps efficiency, of participant behavior, and meeting content, forecasting. It is contemplated that the training module 660 may format, combine, or otherwise alter one or more accumulated meeting metrics for inclusion in an intelligence/learning model.

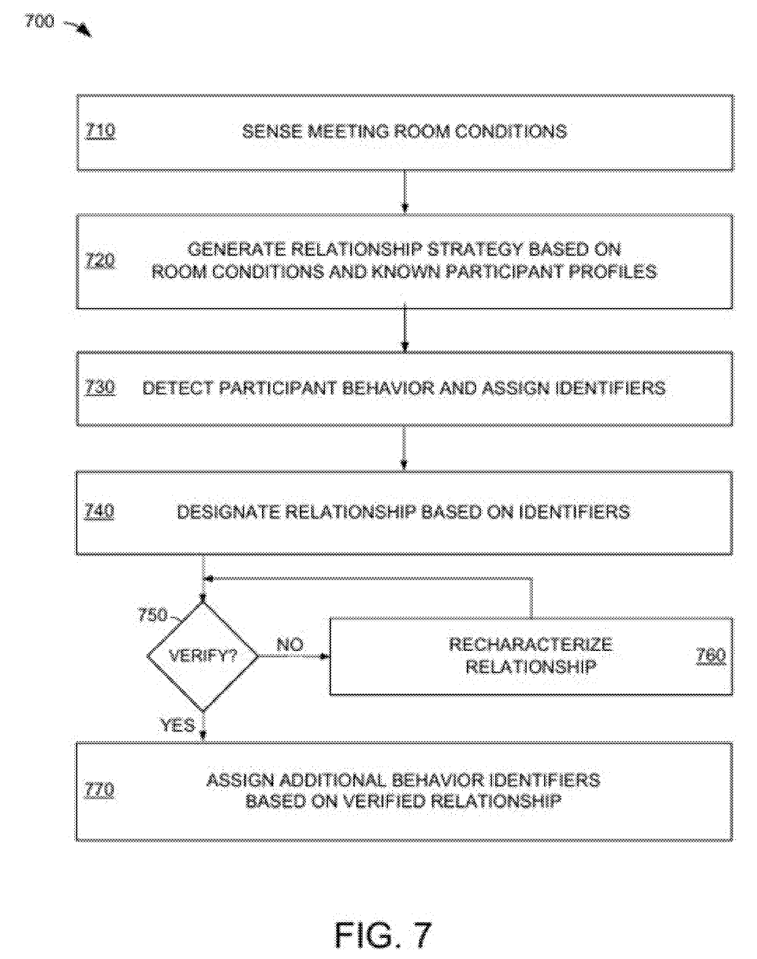

The computing device 610, and conferencing system 600, may be physically positioned in a single meeting space, as shown in FIG. 5, or distributed across multiple, separate locations, which may, or may not, be active in a conference or meeting. Regardless of where the hardware of the conferencing system 600 is physically located, the computing device 610 may conduct any number of routines and procedures as part of a conference meeting to optimize the recording, transmission, and playback of meeting content. FIGS. 7-9 respectively convey flowcharts of assorted conferencing routines that may be conducted in accordance with various embodiments.

FIG. 7 represents an example relationship routine 700 that may be executed as part of a conference meeting by a conferencing system. In accordance with various embodiments, at least the structural conditions of the rooms to be utilized for the conference meeting are sensed in step 710. It is contemplated that each meeting room has at least one sensor, or sensor array, which provides capabilities to detect and measure the position, distance, and likely participant locations within each meeting room. The sensing of conditions in step 710 may characterize detected objects, such as chairs, tables, phone, display, and smartboard.

With the assorted locations, furniture, and likely participant locations evaluated in step 710, a computing device of the conferencing system can generate a relationship strategy in step 720 that is, at least in part, based on the known room conditions and any known participant profiles, which may provide indications of where a participant will sit, stand, or otherwise engage in the meeting. The relationship strategy generated in step 720 may prescribe one or more sets of instructions, prompts, and triggering events that translate sensed participant location, orientation, and movement into interpersonal relationship assignments. For instance, a relationship strategy may set relationship designations, such as subservient, boss-employee, passive, comedic, sarcastic, or combative, that correspond to the respective locations, orientations, and movements of participants.

The predetermined correlations of a relationship strategy may allow the conferencing system to efficiently and accurately detect participant behavior in step 730. That is, the recognition and assignment of an initial relationship designation between meeting participants may allow the conferencing system to alter operating parameters for one or more sensors to better detect participant behavior. As a non-limiting example, a boss-employee relationship designation from the relationship strategy may prompt the activation of a sensor and/or modification of where one or more sensors are collecting information to provide more accurate, efficient, and perhaps precise detection of participant behavior in step 730.

The detection of participant behavior with, or without, an initially assigned relationship between meeting participants provides sensor data that may be interpreted by the computing device of the conferencing system into identifiers. The identifiers, in some embodiments, have a greater resolution of detail than a relationship moniker or the raw information detected from various meeting room sensors. In other words, the identifiers assigned in step 730 may be a combination of information from multiple sensors, such as speech and detected position within a meeting room, or may be an observation generated by the computing device from sensed information, such as forcibly conducting gestures, rolling eyes in an annoyed manner, or uncomfortable fidgeting in a seat.

While any number, and type, of identifier may be assigned by a computing device as part of a conferencing system conducting a virtual meeting, the assignment of identifiers that further provide detail to the participant behavior detected in step 730 allows for a relationship between participants to be further analyzed and designated in step 740. The designated relationship from step 740 may, in some circumstances, be the same as an initial relationship assignment while other circumstances change assigned relationship status in step 740 or simply designate a relationship to participants for the first time. Hence, the assignment of an initial relationship status from the relationship strategy is not required and participants of a meeting may go for any time period without an assigned relationship.

By designating a relationship between meeting participants, a conferencing system may customize the collection of audio and video content through the alteration of operating parameters. For instance, a properly designated relationship assignment may allow for environmental sensors to more accurately and efficiently detect participant behavior while content sensors, such as cameras and microphones, may collect meeting content with greater quality, precision, and integration into a conference meeting. Although meeting participants may have a relationship that is a defined by a single term, routine 700 may identify and designate multiple different relationships between a common pair of meeting participants, such as for different aspects of a presentation, discussion, or topic.

Various embodiments utilize one or more intelligence/learning models in step 740 to designate relationships. The use of an intelligence model may aid in the efficiency and accuracy of identifier evaluation to determine the interpersonal relationship between meeting participants. That is, application of an intelligence model to assigned participant behavior, and corresponding identifiers, may reduce the number of iterations, identifiers, and/or confirmation events that are needed to reliably ascertain interpersonal relationships.

The capability to designate different relationships correlates with an ability to designate a variety of different identifiers for various behaviors, meeting events, activities, and conditions. With such diversity for relationship designations and identifiers, routine 700 may verify, in decision 750, that an assigned relationship and/or identifier is valid and accurately portrays the participant’s behavior as well as the interpersonal interactions with at least one other meeting participant. The verification of a relationship designation and/or identifier is not limited to a particular process or set of rules, but may involve continued observation of the meeting participants after designation and identifier assignment to ensure accuracy. It is contemplated that the conferencing system conducts one or more tests on an assigned identifier, or relationship status, by hypothetically conducting evaluations of the quality of sensor readings when assorted different relationships and/or identifiers are employed, which may iteratively convey the best real-time collection of behavior detection and/or content recording during a meeting.

If a different, or additional, relationship designation from decision 750 may improve sensing operation, step 760 proceeds to recharacterize at least one aspect of a relationship, which may include modification, addition, or removal of identifiers. In the event one or more verification operations from decision 750 determine the existing relationship and/or identifiers are proper, step 770 logs the verification information, such as test results and hypothetical event results. As a result of steps 760 or 770, the activity of the conferencing system serves to improve the future evaluation and characterization of participant relationships and behavior identifiers.

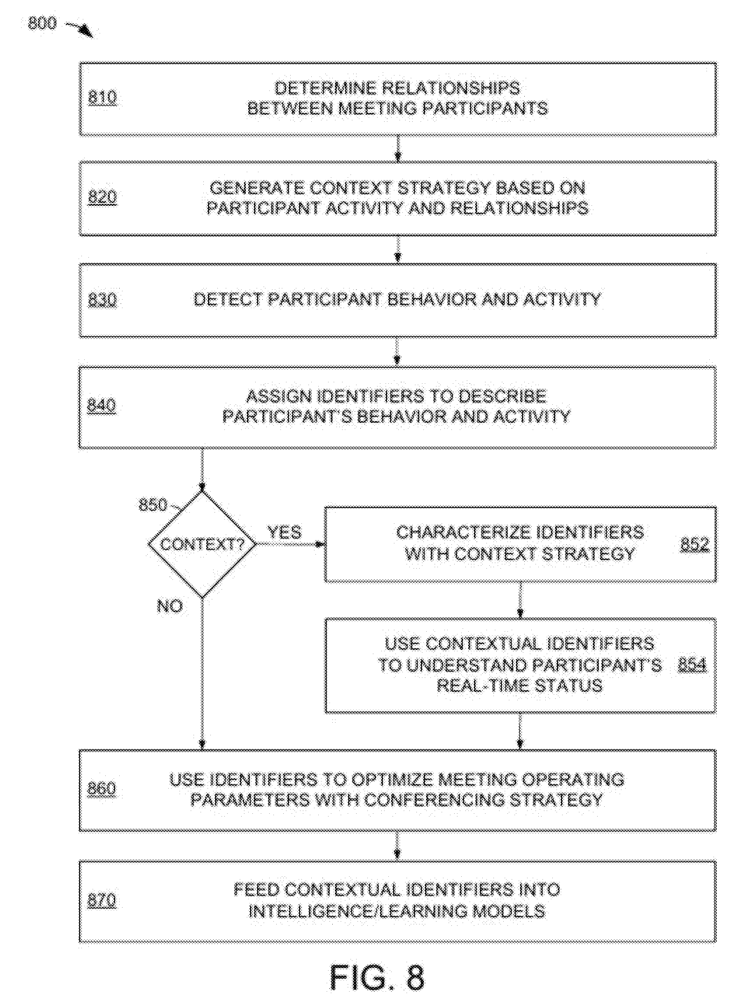

FIG. 8 conveys a context routine 800 that may be conducted by a conferencing system during, and after, a virtual meeting to provide behavioral context to meeting participant’s activity and speech as well as intelligence/learning models. Initially, routine 800 may conduct one or more aspects of the relationship routine 700 of FIG. 7 to determine, in step 810, the relationship between meeting participants. It is noted that the relationship determination of step 810 may be verified, or unverified, with one or more behavioral identifiers corresponding to actions, activities, gestures, and movements.

An understanding, by the conferencing system, of the relationships between assorted meeting participants allows for customization of sensor operating parameters for optimization of sensor performance for the particular real-time meeting conditions. Additionally, the relationships of meeting participants may contribute to the conferencing system generating a context strategy in step 820. That is, the relationship designation, along with recorded, or previously logged, participant activity may be employed to generate a context strategy that prescribes sensor operational parameters for different participants that accurately and efficiently collect pertinent information about the emotional state of a participant without degrading system operation with an overloading volume of sensor data.

It is noted that a conferencing system may generate, and utilize, multiple different strategies concurrently, or sequentially. Hence, a context strategy, which seeks to reduce the amount of sensor data provided to the computing device to precisely determine participant behavior meaning, may coexist, and be selectively employed, with a relationship strategy that seeks to optimize sensor operational parameters to accurately and efficiently capture participant behavior.

In some embodiments, the context strategy prescribes sensor operation that reduces the volume of information to be processed by a system computing device. For instance, the context strategy may prescribe ignoring, or deactivating, one or more available sensors. Other embodiments of a context strategy may alter sensor operation to provide multiple manners of detecting participant behavior. That is, the context strategy may prompt an optical sensor to move from detecting facial gestures to sensing hand gestures while at least one other sensor, such as an acoustic or optical detector, also records the hand activity of the participant.

The ability to proactivity generate the context strategy based on known, or observed, participant activity and designated interpersonal relationships within a meeting may provide seamless detection and verification of participant behavior in step 830 and subsequently assigning identifiers to the behavior in step 840. In contrast to the utilization of the context strategy, the conferencing system would, potentially, miss, or mischaracterize, participant actions and behavior with static sensor settings or monitoring aspects of a participant that are not as important to determining context, meaning, or emotional state. Hence, a context strategy may be selectively utilized during steps 830 and 840 to provide sufficient sensor information for the conferencing system to assign identifiers to describe the participant’s behavior, activity, and movement without unduly burdening the processing capabilities of the conferencing system.

Along with sensor operating parameters that collect participant behavior with customized efficiency and accuracy, the context strategy may prescribe rules and policies to interpret participant behavior, and corresponding identifiers, into meaning. It is noted that meaning rendered by the conferencing system from application of a context strategy may be relative to a topic, participant, relationship, or meeting event, without limitation, to convey what participant behavior actually conveys with respect to a participant’s emotional and mental state. Once identifiers are applied to detected participant behavior and activities, decision 850 evaluates if a context analysis is to be conducted in an attempt to apply meaning to a participant’s conduct.

Determining the context of participant behavior via the context strategy is not required, as illustrated by step 860 that applies identifiers assigned in step 840 to optimize meeting content collection via meeting space sensors, in accordance with a preexisting conferencing strategy. Instead, decision 850 may choose to characterize identifiers assigned in step 840 into one or more behavioral contexts in step 852, in accordance with the prescribed rules/policies of the context strategy. The characterization of behavior/activity identifiers in step 852 may result in assorted identifiers, and more generally behaviors, being ignored or emphasized in determining a participant’s real-time status in step 854. That is, the predetermined context strategy may be applied to assigned identifiers to organize and streamline context determination processing.

Through the characterization of assigned behavior identifiers from step 840 that results in identifiers being emphasized and/or ignored, the pertinent aspects of detected participant behavior may be analyzed in step 854 to render an understanding of the real-time emotional/mental state of a meeting participant. The consequence of determining the real-time participant status in step 854 is a determination, by the conferencing system, of what detected participant actions, gestures, speech, and movement really mean. For instance, an identifier of quiet may be ignored in step 852 while an identifier of annoyed may be emphasized to convey that a participant is getting angrier and more aggressive over time, as opposed to dismissive and apprehensive if all identifiers from step 840 were given equal processing weight.

The accurate understanding of a participant’s real-time emotional/mental status may allow for precise predictions and seamless adaptations of conferencing system sensors to collect meeting data, and content to be broadcast to other meeting sites. In addition, participant behavior identifiers, either characterized in step 852 or not, may be organized and/or formatted in accordance with a training strategy to accurately train one or more intelligence/learning models in step 870. In accordance with various embodiments, step 870 may organize, omit, modify, or multiply behavioral identifiers of a participant in an effort to ensure compatibility and cohesion with existing models. As such, a training model for an intelligence model directed at predicting what meeting participant is to talk next may be trained with contextual identifiers that are differently formatted than identifiers formatted for inclusion into a learning model that predicts participant’s movements or speech patterns.

The contextual identifiers, in some embodiments, may be additionally employed in step 870 to assign interpersonal relationships among meeting participants. As such, the use of intelligence/learning models may be a closed loop as sensed information is gathered and employed with a model to determine relationships and behavioral identifiers that are subsequently fed back into the model with context assigned in step 852. The continual improvement of the intelligence model with contextual aspects while utilizing the model to more efficiently determine participants relationships and behavioral identifiers ensures that the models evolve and progress to provide more accurate determinations from input information.

Without the predetermined strategies utilized in routines 700 and 800, the sophisticated identification of participant interpersonal relationships, adaptation of sensor operating parameters, designating context to participant behavior, and training intelligence/learning models with detected meeting data would be processing intensive and relatively complex to the point of likely degrading system performance, which may correspond to delays, errors, and an otherwise unrealistic meeting experience. Various embodiments of a conferencing system may employ any number of strategies, routines, steps, and decisions individually or concurrently any number of times in the course of preparing for, and executing, a virtual conference meeting.

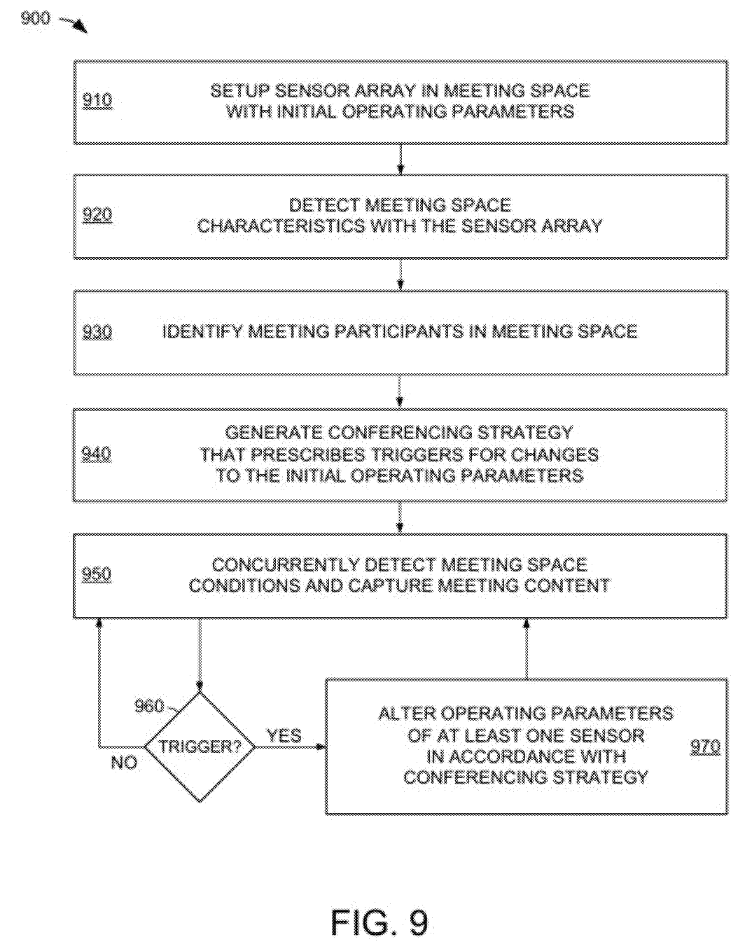

FIG. 9 conveys a general conferencing routine 900 that may be conducted by a conferencing system in an effort to provide seamless optimization of meeting content recording and playback. In each meeting space to be included in a virtual meeting combined by a conferencing system, step 910 conducts a setup procedure, which may differ from meeting site to meeting site, which installs a sensor array that is connected to a processing unit. The setup of step 910 may further include establishing an initial set of operating parameters for the various sensors of the array, which may be similar or dissimilar to one another.

As a non-limiting example of the setup of step 910, a sensor assembly may be installed on a ceiling of a meeting room while other sensors are positioned to detect assorted meeting room conditions, participant activity, audio meeting content, and video meeting content, as directed by a local processor, such as a local computing device or a microprocessor of the sensor assembly. It is contemplated that a diverse variety of optical, mechanical, and acoustic sensors are installed as part of the setup of step 910 with initial operating parameters that detect meeting space characteristics in step 920. Such meeting room characteristics may be the type and location of furniture and objects as well as the likely positions of participants within the space, such as seated, doorway, or proximal to a presentation display.

With the meeting space characteristics detected and understood by the sensor array, step 930 may execute to identify meeting participants in response to an operational prompt, such as a participant entering the meeting space or a timed start to a meeting. The identification of participants in step 930 may be carried out in a variety of manners, either individually, concurrently, or sequentially. For instance, the sensor array may be operationally configured to detect a participant’s facial features, physical size, walking gait, speech patterns, or nametag to determine if the participant is known and has a preexisting profile that describes more about the participant. That is, a conferencing system may maintain, or access, a portfolio of known participants that provides any number and type of descriptive information, such as relationships to other participants, behavior tendencies, and pertinent gestural identifiers.

Even if a participant is unknown to the conferencing system, the sensed participant characteristics in step 930 may allow for the application of known profiles for similar participants to initially be used to understand the content of the meeting until a unique profile may be constructed for the participant over time. The detected understanding of the meeting space complements the knowledge, or reference, of the meeting participants to allow the conferencing system to generate a conferencing strategy in step 940. The conferencing strategy may prescribe any number, and type, of operational triggers and prompts to alter the operating parameters of one or more sensors of the meeting space.

The conferencing strategy generated in step 940 may differ from the other strategies that may be created, maintained, and executed by a conferencing system. For instance, a conferencing strategy may be directed to sensor alterations that provide optimal audio and video content recording while other strategies format detected information for model training or alter sensor operating parameters to optimize the detection of particular conditions, such as gestures, speech, position, or movement. By prescribing operational triggers and prompts in a conferencing strategy directed at optimizing audio and video recording during a meeting, a conferencing system may more efficiently and accurately adapt to changing meeting conditions with minimal performance degradation, such as lag, mismatched audio, and incorrect video.

With an understanding of the meeting space and the meeting participants, along with the generation of the conferencing strategy, meeting content may be collected by one or more sensors of the sensor array in step 950. It is contemplated, but not required, that the collection of meeting content in step 950 is conducted concurrently with separate sensors of the sensor array, such as cameras and microphones that are each connected to a conferencing system processing unit. The collection of meeting content may last for any amount of time as decision 960 evaluates if an operational trigger of the conferencing strategy has been met, or is eminent.

If decision 960 determines an operational trigger is set, or has been detected as true, step 970 proceeds to alter the operational parameters of at least one sensor of a meeting space sensor array in accordance with the conferencing strategy. In the event no trigger is met, decision 960 may return to step 950 where meeting content is continually collected and processed by the conferencing system. Through the use of predetermined adaptations of operational parameters based on known participant activity and behavior, the conferencing strategy provides functional adaptations that are juxtaposed to systems that simply react to detected meeting conditions by trying one or more operating parameter alterations in an iterative attempt to find optimal settings for current meeting conditions.

It is contemplated that the next advancement in artificial intelligence may center around the development of knowledge of human relationships, and that one source of the intelligence training data may come from the audio/visual industry. One example would be a Video-LLM that is aware of subtle human behaviors or facial expressions that enhances the model’s utility, value, or accuracy when either generating audio/video or interpreting audio/video. Among others, the conferencing space offers a unique and well controlled opportunity to gather simultaneous, audio, video, and contextual training data. Therefore, a potential exists to use intelligently formatted training data from real-time conference meetings to improve one or more models.

Currently, contextual information is lacking that would allow intelligence/learning models to understand the relationship between the human participants present in the audio and video feeds. Contextual information about the human in multiple audio and video feeds would at least include their relative location and orientation, and ideally the aforementioned characterization of their relationship and behaviors. From such contextual information, an intelligence/learning model can decipher the human’s relationship, allowing such a model to either generate more accurate and life like video content, or allow such a model analyzing video to determine the participants behavior, relationship, mood, etc. For example, two speakers facing one another during a conversation may be deciphered as one subject presenting while a group listens or a group of concert goers all facing a performer on stage may be deciphered as a single subject. From the content of the audio and video feeds, and deciphered contextual knowledge of the human participants, an intelligence/learning model has the potential to decipher all manner of details about human relationships that are otherwise impossible to glean from one-sided, one-subject videos commonly available today.

In accordance with various embodiments, context data, such as time, date, speaker’s position, speaker’s rotation/orientation, meeting description, relationship, and behaviors, may be embedded into an encoded, low resolution, audio/video stream for long-term storage, which would provide a suitable means for accumulating the aforementioned training data. Some embodiments propose the use of a multi-modal context sensor assembly, working within an audio/visual system, to gather positional data on human subjects and furthermore combining audio/video data from other cameras and microphones to determine the orientation of the human subjects. The position and orientation data may then form the contextual human relationship data that is then combined with video and audio feeds of the specific human subjects to complete the model training data set required to train an intelligence/learning model capable of understanding human relationships.

Generally, embodiments of a conferencing system provide value in a market expected to grow from a value of roughly $2.5 billion to $30 billion in the next decade. A hypothetical model training data set that enables intelligence/learning models to understand human relationships and behaviors would have countless applications with monetary value. A method for collecting and using contextual data for adding human relationship information to an intelligence model has the potential to be valued at a significant fraction of the dataset’s total.

It is contemplated that one-on-one and other small conference room meetings have the greatest potential to generate audio/visual content and context data needed to create the data set that includes useful human interactions. The vast majority of such meetings may be considered proprietary and thus the raw data is highly unlikely to be made available to another company for training a model. However a sufficiently large company could employ data anonymization to create a valuable Video LLM or other model from their own data and then make that model publicly or commercially available.

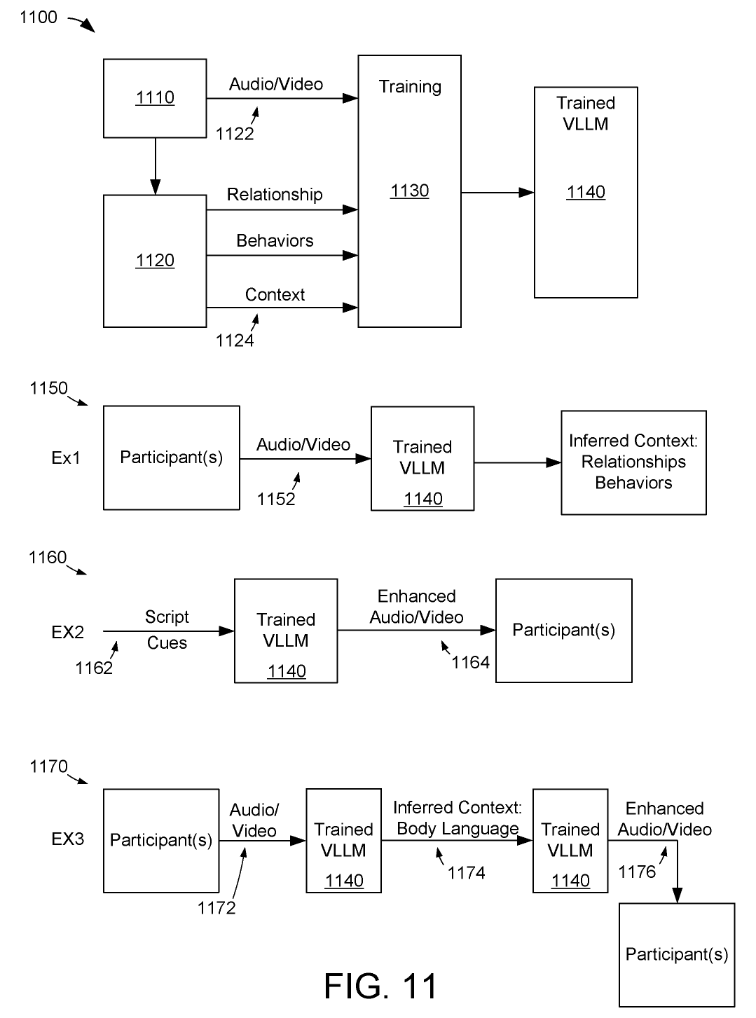

FIG. 11 shows a non-limiting example use of a multi-modal context system 1100 that utilizes at least one multi-modal sensor 1110 in accordance with some embodiments to facilitate training of a Video-LLM. In addition to typical audio and video signal output 1122 from the multi-modal sensor 1110, the training set may include contextual, behavioral, and relationship data, which may be collectively characterized as derived output 1124, as generated by one or more, local or remote, computing devices 1120. The sensor 1110 output 1122/1124 allows the model to recognize and classify distinguishing features of the audio

and video outputs 1122 as they relate to human behavior, facial responses, etc., which may be characterized as model training 1130 that produces a trained model 1140.

Once such a Video-LLM (VLLM) is trained 1140, it can be leveraged in a variety of applications analogous to the present use of text based LLMs. In example 1150 (Ex1), a video 1152, and/or audio, of one or more is fed into the trained model 1140 and model is able to infer, and therefore produce, information about the participants relationship and behaviors. The model 1140 may, for example, recognize that this video is of a dominant and passive participant or that there is sarcasm in use, where such inferences are not based solely on the words exchanged, but rather the entire combination of video and audio data including such subtleties as facial expression that are made in response to spoken words.

In example 1160 (EX2), a script and contextual cues 1162 are fed into a trained Video LLM 1140 and the model produces an accurate video of high quality 1164 that is based on the contextual cues such as understanding if the character is presenting to a group or participating in a one-on-one conversation. In example 1170 (EX3), a video equivalent of a help chat bot, but with video, may be provided. For instance, audio/video data 1172 relating to a caller’s video may be fed into the trained Video-LLM 1140 to allow the chat system to understand the caller’s behavior, for example, fidgeting or impatience as inferred context 1174. The video chat bot, in some embodiments, may then respond with video/audio 1176 that may be appropriately tuned to the caller after again being fed to the trained model 1140, which may provide the caller with a much more life-like experience than if no inferred context 1174 was discovered and subsequently utilized.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. A method comprising:
positioning a sensor array in a meeting space;
detecting, with the sensor array, an activity of a participant present in the meeting space;
assigning, with a computing device connected to the sensor array, at least one identifier to describe the activity;
characterizing, with the computing device, the at least one identifier as a behavioral context; and
altering, with the computing device, at least one operational parameter of the sensor array in response to the behavioral context.

2. The method of claim 1, wherein the behavioral context is characterized by the computing device as an emotional state of the participant.

3. The method of claim 1, wherein the at least one identifier describes an emotion to the detected activity.

4. The method of claim 3, wherein the emotion is sarcasm and the detected activity is listening.

5. The method of claim 1, wherein the sensor array comprises at least one acoustic sensor, at least one optical sensor, and at least one environmental sensor.

6. The method of claim 1, wherein the computing device utilizes a context strategy to assign the at least one identifier to describe the activity.

7. The method of claim 6, wherein the context strategy proactively sets rules and policies for operation of the sensor array that aid in the efficient characterization of behavior of the participant into the at least one identifier.

8. The method of claim 1, wherein at least one optical sensor and at least one acoustic sensor are used to detect the activity of the participant.

9. The method of claim 1, wherein the sensor array is configured as a single component positioned in a central location of the meeting space.

10. The method of claim 1, wherein the computing device formats the at least one identifier to train an intelligence model.

11. A method comprising:
positioning a sensor array in a meeting space;
sensing, with the sensor array, at least one condition of the meeting space;
detecting, with the sensor array, a first participant present in the meeting space and a second participant present in the meeting space;
detecting, with the sensor array, an activity of the first participant;
assigning, with a computing device connected to the sensor array, at least one identifier to describe the activity;
characterizing, with the computing device, the at least one identifier as a relationship based on a relationship strategy; and
verifying, with the computing device, the relationship in response to detected behavior of the first participant.

12. The method of claim 11, wherein the computing device assigns at least one behavioral identifier to the first participant after verification of the relationship between the first participant and the second participant.

13. The method of claim 11, wherein the computing device is configured to assign at least one identifier to the second participant based on activity of the second participant detected by the sensor array, the at least one identifier assigned to the second participant being different than the at least one identifier assigned to the first participant.

14. The method of claim 11, wherein the computing device assigns an initial relationship between the first participant and the second participant prior to detecting the activity of the first participant.

15. The method of claim 11, wherein the relationship strategy alters operational parameters of the sensor array to assign multiple different identifiers to the activity.

16. The method of claim 11, wherein the computing device trains an intelligence model with the at least one identifier.

17. The method of claim 11, wherein an intelligence model is used by the computing device to characterize the at least one identifier as a behavioral context.

18. The method of claim 11, further comprising identifying, with a computing device connected to the sensor array, a first profile corresponding to the first participant and a second profile corresponding with the second participant; and
generating, with the computing device, a relationship strategy based on the at least one condition, the first profile, and the second profile.

19. The method of claim 11, wherein the computing device is configured to recharacterize the relationship in response to the detected behavior of the first participant.

20. A system comprising:
a sensor array positioned within a meeting space, the sensor array having an initial set of operating parameters;
a computing device connected to the sensor array;
wherein the sensor array is configured to detect activity of at least two participants;
wherein the computing device is configured to assign at least one identifier to the detected activity;
wherein the computing device is configured to generate a relationship strategy prescribing a relationship set of operating parameters for the sensor array to detect interpersonal relationships between meeting participants;
wherein the computing device is configured to designate an initial relationship status to a pair of meeting participants in response to the activation of the relationship set of operating parameters for the sensor array;
wherein the computing device is configured to generate a context strategy prescribing a context set of operating parameters for the sensor array to detect behavior of at least two meeting participants;
wherein the computing device is configured to assign identifiers to detected behavior of a meeting participant with the computing device, the identifiers describing meaning corresponding with the detected behavior;
wherein the computing device is configured to generate a conferencing strategy prescribing a content set of operating parameters for the sensor array to collect audio content and video content from meeting participants with customized accuracy;
wherein the computing device is configured to conduct context analysis on the at least one identifier to determine a real-time participant status based on an intelligence model accessed by the computing device;
wherein the computing device is configured to choose an intelligence model to train with the at least one identifier; and
wherein the computing device is configured to format the at least one identifier to train the intelligence model.
